(19) United States
(12) Patent Application Publication
(10) Pub. No.: US 2006/0282280 A1
(43) Pub. Date: Dec. 14, 2006

(54) Ticket and data management

(76) Inventors: Christian Stotz, Santa Clara, CA (US); James W. Waite, Los Gatos, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/433,190

(22) Filed: May 11, 2006

Related U.S. Application Data
(63) Continuation-in-part of application No. 11/114,713, filed on Apr. 25, 2005.
(60) Provisional application No. 60/592,835, filed on Jul. 29, 2004.

(51) Int. Cl. G06Q 99/00

(52) U.S. Cl. 705/1

(57) ABSTRACT

A locator including a processor; a memory configured to store location data; a locator circuitry coupled to the processor and configured to receive and process signals related to the location of a utility line; and a visual data input device coupled to the processor and configured to receive visual data, wherein the processor is adapted to reconfigure the location data based on the visual data.

### BACKGROUND

1. Field of the Invention

The present invention relates to underground locators and, in particular, to underground locators in combination with a network to manage electronic tickets.

2. Background of the Invention

Excavators are the number one cause of damage to underground utility lines. In order to reduce the risk, many states have a OneCall center that requires excavators and property owners to call the OneCall center before digging underground. These centers then contact the underground utility line owners, informing them of an intention to dig in a specific area. Local and federal regulations are in place to mandate utility line owners to respond with a prescribed action. Compliance may result in thousands upon thousands of response activities whether an underground utility is potentially at risk or not.

One such activity is opening a ticket that defines the job site and the impacted utility. In servicing a ticket, the utility company must either locate and mark the location of the utility at the property (known as a “locate”) or respond to an excavator that none of the company's utility lines are located at the potential excavation site (known as a “no-locate”). The majority of ticket requests do not have utility lines in the vicinity of the excavation requests, but the utility company is still required to notify the excavator that the utility company has no utilities in the area of the excavation.

Some companies have hundreds of thousands of no-locate and locate ticket openings per year. Due to the large amount of ticket openings, automated tracking methods are commonly used to denote the status of the ticket. Most tickets are cleared without a site visit by examination of the site address on the ticket. When a utility company clears a ticket by performing a locate on site, detailed measurements resulting from that locate are not required to be attached to the cleared ticket. The excavation and contracting industry rely heavily on the marked locate (painted marks denoting the centerline of the utility line) to allow subsequent safe digging operations.

Most of the time the process works and the dig is safely performed. But errors can occur at several points in the chain (lost paper tickets, undetectable sections of the utility line due to low signal strength, site address entry errors, inaccurate locates due to interference, inaccurate “as-built” records of the presence of a specific utility, miscommunication between job-site locate technicians and excavators). As a result, an excavation of the utility line could occur that could damage or break the utility line and potentially physically injure the third party excavator. Generally, if the third party excavator is hurt, there are court awarded damages to the third party and the rising cost of litigation hampers the profitability of the utility companies. Often the integrity of the locate itself is called into question, and the actual equipment used for a particular job is examined for accuracy.

In addition, upon new excavation requests, in the absence of having archived detailed measurement data from the site of a previous locate, there are instances where the utility companies will have to revisit a particular area having a possible utility line. The redundancy in the OneCall ticket processing can be burdensome and costly for the utility companies.

Therefore, in light of the foregoing description, it could be desirable to develop a system for a ticket data management to reduce the potential for errors in the ticket management process, to include a method of measurement and calibration data archival for use in potential liability proceedings, to allow retrieval of measurement data from previous locates on the site to aid in new ticket clearing, and hence to consider the utility locate equipment as an integral component of the OneCall ticket processing loop. As a result, this will save utility companies money by improving production by reducing redundancy, preventing the excavation of utility lines and preventing the physical injuries to excavators and third parties resulting from the excavated lines.

### SUMMARY

In accordance with the invention, some embodiments comprise a locator including a processor, a communication interface adapted to communicate ticket data between the processor and an external database, a memory adapted to store the ticket data received from the external database, and a locator circuitry coupled to the processor and adapted to receive and process signals related to the location of a utility line, wherein the processor is adapted to reconfigure the ticket data based on data regarding the location of the utility line.

In accordance with some embodiments of the invention, a ticket management system includes a network, an external database adapted to store ticket data and transmit ticket data to the network, and a locator device adapted to receive ticket data from the network, wherein the locator device processes data relating to a location of a utility line, reconfigures the ticket data based on the processed data and communicates the reconfigured ticket data to the network.

In accordance with some embodiments of the invention, a method for reconfiguring ticket data at a locator, the method includes storing ticket data at a memory, detecting whether a signal has been received regarding a location of a utility line processing data based on the signal, and reconfiguring the ticket data based on the processed data.

In accordance with some embodiments of the invention, a method for updating ticket data within a system wherein the system includes a network, at least one database and a locator, the method includes receiving ticket data at an external database, transmitting ticket data from the external database to a locator, reconfiguring the ticket data at the locator based on a location of a utility line, and transmitting the reconfigured ticket data to the network.

In accordance with some embodiments of the invention, a method for reconfiguring ticket data at a locator, the method includes means for storing ticket data, means for detecting whether a signal has been received relating to a location of a utility line, means for processing data based on whether a signal has been received at the detection means, and means for reconfiguring the ticket data based on the processed data.

In accordance with some embodiments of the invention, a method for updating ticket data within a system wherein the system includes a network, at least one database, and a locator, the method includes means for receiving ticket data at a first database, means for transmitting ticket data from a first database to a locator, means for reconfiguring the ticket data at the locator based on a location of a utility line, and means for transmitting the reconfigured ticket data to the network.

It is to be understood that both the foregoing general description and the following detailed description are exemplary and explanatory only and are not restrictive of the invention, as claimed. These and other embodiments are further discussed below with respect to the following figures.

### BRIEF DESCRIPTION OF THE DRAWINGS

FIG. 1 illustrates the aboveground use of a line locator used to locate the position of multiple underground utility lines according to some embodiments of the present invention.

FIG. 2A illustrates a locator according to some embodiments of the present invention.

FIG. 2B illustrates an example block diagram of the internal configuration of the locator illustrated in FIG. 2A.

FIG. 3A illustrates a block diagram of a system for updating the ticket data within the network according to some embodiments of the present invention.

FIG. 3B illustrates an example web page for synchronizing the ticket data according to some embodiments of the present invention.

FIG. 4 illustrates a flow chart presenting a method for reconfiguring a ticket data at a locator, such as that shown in FIGS. 2A and 2B, according to some embodiments of the present invention.

FIG. 5 illustrates a flow chart presenting a method for reconfiguring ticket data within a system, such as that shown in FIG. 3A, according to some embodiments of the present invention.

In the figures, elements having the same designation have the same or similar functions.

### DESCRIPTION OF THE EMBODIMENTS

Utility lines are often buried underground or concealed in walls and therefore are not readily accessible or identifiable. It is often necessary to locate these concealed utility lines in order to repair and replace them. It is also important to know the location of the utility lines in order to avoid them while excavating an area. Examples of hidden utility lines include pipelines for gas, sewage, or water and cables for telephone, television, fiber optic, or power.

There are various ways to locate concealed objects, for example, using line locators or marker locators. Line locators are appropriate when seeking electrically conductive utility lines, such as metallic pipelines and cables. Line locators may also be used for finding non-electrically conducting utility lines when the utility line is marked with a conducting trace wire or trace tape buried along the utility line. Please note for future reference that utility lines can encompass both conductive and non-conductive utility lines. The process of applying an AC signal to the utility line at an accessible point and detecting the resulting electromagnetic radiation is well known in the art. When an AC signal is applied to the utility line, the utility line generates an electromagnetic field along its entire length that can be detected by a line locator. In such an application, a line locator used above ground detects electromagnetic emissions from utility lines underground. A fully digital implementation of an electromagnetic line locator is described in U.S. patent application Ser. No. 10/622,376, “Method and Apparatus for Digital Detection of Electromagnetic Signal Strength and Signal Direction in Metallic Pipes and Cables”, by James W. Waite and Johan D. Överby, which is herein incorporated by reference in its entirety.

Utility lines may also be marked with electronic markers, either at surface level or underground. Buried electronic markers may be used to locate and identify a number of concealed objects such as cables, pipes, access points, underground stock piles, survey points, and septic tanks. Typically, marker locators locating passive, active, or smart markers generate an electromagnetic field that induces a response in the marker that can be monitored by a detector of the marker locator.

Generally, electronic markers consist of two types: active markers and passive markers. Active markers radiate a signal detectable at the surface; however, they require a power source. Passive markers, on the other hand, require no power source and become active when induced by an external electromagnetic field, which can be generated with a portable power source.

Passive markers typically include a multi-turn wire loop (coil) tuned with a capacitor to a pre-determined resonant frequency. A flexible implementation of an electromagnetic marker locator is described in U.S. patent application Ser. No. 10/227,149, “Procedure and Device for Determining the Location of Buried Electronic Markers,” by Hubert Schlapp and Richard Allin, which is herein incorporated by reference in its entirety, and also U.S. patent application Ser. No. 10/759,747, “Method and Apparatus for Digital Detection of Electronic Markers Using Frequency Adaptation”, by Johan D. Överby and James W. Waite, which is herein incorporated by reference in its entirety.

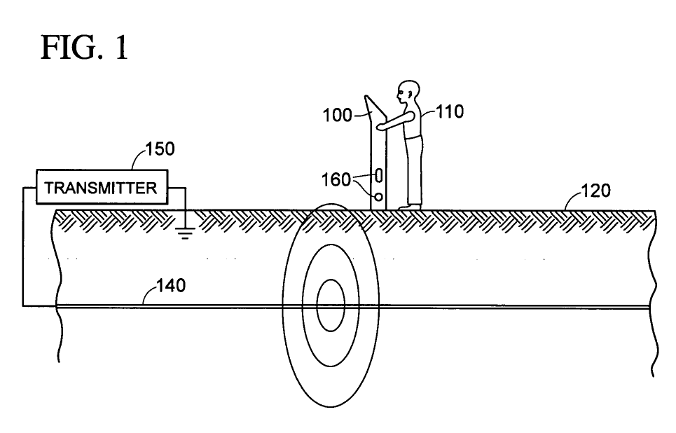

FIG. 1 illustrates a line locator 100 according to some embodiments of the present invention as operated by a location technician 110. A target utility line 140 is energized by an electric current from transmitter 150 and emits an electromagnetic field. In order to detect the electromagnetic field, line locator 100 can have coil detectors 160 for measuring the magnetic field generated by the conductive utility line. In general, the location technician 110 directs the line locator 100 towards ground level 120. Measurements of the magnetic field can be taken at multiple positions of line locator 100 as location technician 110 walks transversely across target utility line 140.

Alternatively, in some embodiments of the invention, a marker locator can be used to detect pipes (usually not-conductive, e.g., a gas line). A marker locator often includes a transmitter and a receiver. A location technician 110 can operate the marker locator to transmit electromagnetic radiation at a frequency from a transmitter mounted on the marker locator. Once a marker detects the frequency from the transmitter, the marker locator can emit electromagnetic radiation at its resonant frequency. Each marker can be coded with a different resonant frequency in order to identify the type of utility line that each frequency respectively marks. The receiver of the marker locator detects radiation emitted at the resonant frequency.

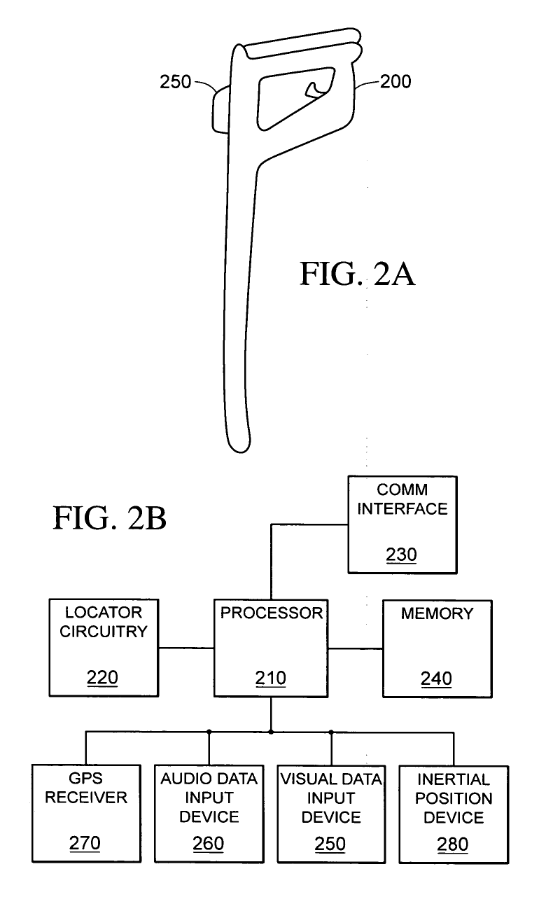

FIG. 2A shows a conventional locator 200, such as line locator 100. Alternatively, locator 200 may also be another type of locator that locates items associated with utility lines, such as a marker, metal, radar, acoustic water leaks, etc. In accordance with some embodiments of the present invention, locator 200 can receive, store, display, and reconfigure ticket data. If locator 200 detects the presence of a utility line 140, the ticket data can be updated based on the located utility line. On the other hand, if the locator does not detect the presence of the utility line, the ticket data can be updated to record a no-locate condition.

Although locator 200 illustrated in FIG. 2A is a hand-held locator, embodiments of a locator according to the present invention can be mounted on vehicles or included in other devices that can be moved relative to target utility line 140. Locator 200 is movable in order to sample the electromagnetic field generated by target utility line 140 that contributes to the electromagnetic field sampled by locator 200. Utility line markers can be detected in the similar manners stated above. In some embodiments, locator 200 includes a visual data input device 250.

It is often difficult to distinguish signals resulting from target utility lines 140 and signals resulting from a neighboring utility lines 130 where bleedover has occurred, even if the locator circuitry of locator 200 provides an indication of the signal direction as well as signal strength. A system that provides an indication of the signal direction as well as signal strength is described in U.S. patent application Ser. No. 10/622,376, by James W. Waite and Johan D. Överby (the '376 application), which is assigned to Metrotech Corporation and herein incorporated by reference in its entirety. U.S. patent application Ser. No. 10/842,239, by Hubert Schlapp and Johan D. Överby (the '239 application), which is assigned to Metrotech Corporation and herein incorporated by reference in its entirety, discloses a new signal processing structure called “bleedover decoupling” that allows a locator system to distinguish between signals received from a targeted utility line 140 and signals received as a result of bleedover to neighboring utility lines 130.

FIG. 2B illustrates a block diagram of a locator 200 according to some embodiments of the present invention. Locator 200, shown in FIG. 2B, includes a processor 210 that controls various aspects of locator 200. Locator circuitry 220 is controlled by processor 210. Locator circuitry 220 for locator 200 can be one or more coil detectors that measure the magnetic field generated at the buried utility line.

On the other hand, the locator circuitry 220 in a marker locator can include a transmitter and a receiver. The transmitter is used to transmit at least one radiation frequency. If the transmitted radiation frequency is detected by a marker, the marker has the ability to emit a resonant frequency that could be received at the receiver. Please note that future references to locator circuitry 220 for locator 200 can include locator circuitry 220 for either a line locator or a marker locator.

Locator circuitry 220 has the ability to translate the detected signal into its corresponding data signal and then communicate the data signal to processor 210. Based upon this data signal, processor 210 has the ability to determine the location of the corresponding one or more utility lines, the depth of the utility lines and the type of utility lines. If the locator circuitry does not receive a signal detecting the presence of a utility line, then processor 210 can, in some embodiments, determine that a no-locate was apparent at the particular site, or more likely, on a particular section of line at the site. In scenarios in which the targeted line cannot be detected because of bleedover interference (high magnetic field distortion), or because the depth of the target is too great for reliable detection, locator 200 can automatically update the ticket data with GPS coordinates of the undetectable line section, or allow locator technician 110 to manually input the no-locate ticket data at locator 200.

Processor 210 can communicate with a communication interface 230. Communication interface 230 can be configured to communicate directly with a network or may be utilized to couple with another device such as an external computer. Communication interface 230 can be a RS-232 serial interface or any suitable communication interface. Communication interface 230 can utilize any communications technology, wired or wireless.

If communication interface 230 receives ticket data from a network, processor 210 can channel the ticket data from communication interface 230 to memory 240. As shown below, memory 240 has the ability to store ticket data from the network until processor 210 is utilized to reconfigure the stored ticket at memory 240 to the reconfigured ticket data. Memory 240 can be any suitable memory.

In addition, processor 210 can communicate with various alternative additions to locator 200. These alternative additions may provide data to be used to reconfigure the ticket data. These additions can be built in the locator, attached directly to locator 200, or alternatively, could be added onto a user interface. The user interface can be a computer or other device and can be coupled to locator 200. The first addition could be a visual data input device 250 that can be integrated into locator 200. Visual data input device 250 can be utilized to allow a location technician 110 to provide a visual reference point to locate a utility line location. Location technicians 110 often take pictures of a specific object to act as a reference point. The picture allows future location technicians to locate the utility line more easily. Sometimes, pictures are taken of the marking paint placed on the ground to serve as proof that the locate was done (Marking paint usually doesn't last long, and can sometimes disappear completely after a few weeks, depending on weather). The visual data input device 250 can be a camera, a video recorder or combination of both.

The second addition could be an audio data input device 260 that can be used to allow location technician 110 to provide audio notes to the ticket data. The audio input device allows the location technician to provide audio notes to notify future location technicians of the special features of the area or to allow for the operation of the locator by voice recognition software. The audio data input device 260 can be a microphone, an attached headset or any other suitable audio input device.

Another addition can be a GPS receiver 270 that has the ability to communicate with processor 210. Once a location technician has scanned the particular area for the utility line, the location technician can request the GPS coordinates. GPS receiver 270 can then receive the GPS coordinates from a set of GPS satellites, which can allow locator 200 to determine the exact or approximate whereabouts of targeted utility line 140. In addition, the data generated at GPS receiver 270 and locator circuitry 220, in combination, can be used to map the specific location of the utility lines. Please note that a GPS receiver can be replaced or be used in combination with a range finder or an inertial position-tracking device 280. An inertial position-tracking device is described in U.S. patent application Ser. No. 10/407,705 “Buried Line Locator with Integral Position Sensing”, by Gordon Pacey and assigned to Metrotech Corporation, which is herein incorporated by reference in its entirety. U.S. patent application Ser. No. 10/997,729 “Centerline and Depth Locating Method for Non-Metallic Buried Utility Lines,” by James W. Waite and assigned to Metrotech Corporation, which is incorporate herein by reference in its entirety and discloses utilization of inertial sensors to result in transverse (to the line) position estimates.

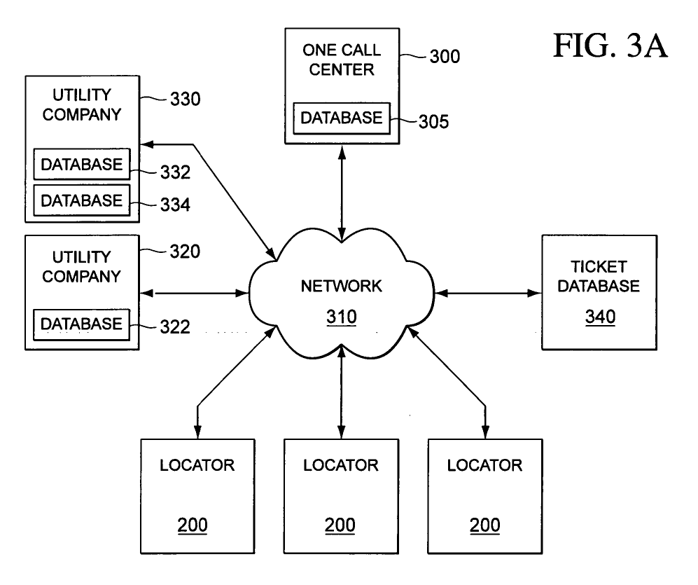

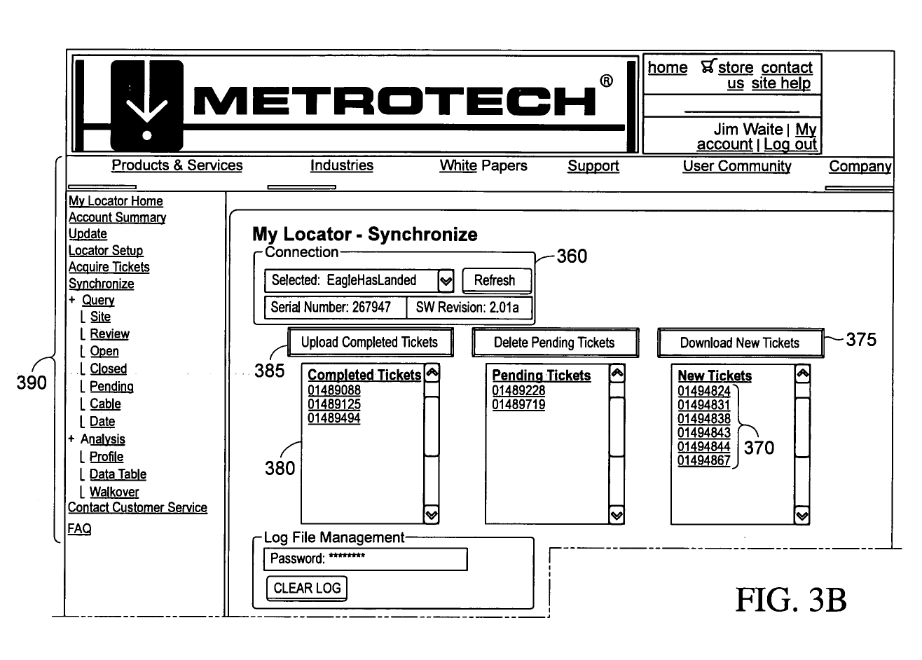

FIG. 3A illustrates a block diagram of a system for updating the ticket data within a network according to some embodiments of the present invention. A OneCall center 300 has been established in most states. The purpose of OneCall center 300 is to maintain and operate the notification system for excavation and relaying information for safeguarding underground facilities. For example, the state of Minnesota's OneCall center processed over 750,000 excavation requests and generated over 4.7 million tickets in 2002. To initiate the process, OneCall center 300 receives either a phone call, fax, or e-mail from a third-party stating the intention to excavate a particular area. OneCall center initiates the process by opening a ticket based on the message from the third-party. OneCall center updates its ticket database 305 based on the necessary ticket information. The ticket information can include a ticket identification number, grid information, the location of the excavation, the types of utilities, whether the ticket has been completed, or any other ticket-related data. OneCall center 300 can then send the ticket data through a network 310 to notify the affected utility companies 320, 330. In some instances, OneCall center 300 has to contact at least 15 different utility companies in order to determine whether an excavation site is safe or not. OneCall center 300 has the ability to send ticket data to the one or more utility companies 320, 330 via transmitting the ticket data through a network. It will be readily appreciated by one of ordinary skill that OneCall center 300 can notify the utility companies via fax, mail, or e-mail. Please note that any reference to OneCall center 300 can include any employee, database, or computer system of OneCall center 300.

The preferred network environment is a global network, such as the Internet. However, network 310 is not limited to a global network such as the Internet, and in general can be used with any type of network or combination of-networks conveying any area size including but not limited to local area networks, campus wide networks, and/or wide area networks. The network or combination of networks can include wired networks and/or wireless networks communicating via applicable network and communication standards.

Network 310 is coupled to OneCall center 300, at least one ticket database 340, and at least one locator 200. There may be any number of ticket databases 330 and locators 200. Further, any number of utility companies 320, 330 can be coupled to network 310.

Once utility company 320 has received the ticket data from network 310, utility company 320 has the ability to create a ticket account within its own utility company database 322. In some instances, utility companies 320 and 330 may monitor multiple types of utility lines and may need one or more utility company databases 322, 332, and 334 in order to record ticket data. Please note that any reference to utility company 320, unless properly distinguished, can include any employee, database, or computer system of the utility company 320. In some embodiments, utility company 320 can be in direct contact with OneCall center 310. In some embodiments, utility company 320's computer system can automatically enter the ticket information received from network 310 into the utility company's database 322. The utility company's database 322 may include such ticket information as a ticket identification number, a grid number, the frequencies of the radiation utilized in the locate, an address, whether a ticket was a locate or a no-locate, or any other ticket-related data.

The one or more utility companies 320, 330 can then transmit their ticket data through network 310 to a ticket database 340. Please note that the reference to ticket database 340 can include a server or a computer system at the site of ticket database 340. In some embodiments of the invention, ticket database 340 may communicate directly with the utility company's databases 322, 332, and 334. Additionally, it will be readily appreciated that ticket database 340 can store any type of information. Once ticket database 340 receives the open ticket data, ticket database 340 can determine whether a locate has been previously performed at this area. If so, ticket database 340 has the ability to transmit the information relating to the locate through network 310 to either the relating utility companies 320, 330 or OneCall center 300. If not, ticket database 340 may open or update its ticket data records and transmit at least some of the ticket data through network 310 to locator 200. The ticket records stored at ticket database 340 can include a ticket identification number, the location of paint on the ground (via visual data), the types of utilities, the specific position and depth of the utilities (including the raw magnetic field strength and inertial tracking data used to compute position and depth), the frequencies of the radiation utilized in the locate, the direction of the signal on the cable, the level of bleedover interference, GPS coordinates, visual data, audio data, or any other ticket-related data. Please note that the ticket database 340 can differentiate itself from the utility company 320's database and the OneCall center 300's database since the ticket database 340 has the ability to store all ticket information for each of utility companies 320, 330 and can have more comprehensive ticket data records. In some of the embodiments, if locator 200 includes all additional interfaces 250, 260, 270, and 280, the record size of the logged data for a particular site is approximately 100 Kbytes. Thus, if a single locator 200 is used throughout the course of a day to accomplish 20 locates prior to synchronization with ticket database 340, then the logging memory size of locator 200 must be in excess of 2 Mbyte.

The advantage of having a ticket database 340 is that the administrators of ticket database 340 have full control of the information within ticket database 340. Based upon this control, the administrators have the ability to determine the ticket data to be transmitted to each of locators 200 and the type of data to be collected by each locator 200. Ticket database 340 has the ability to collect all of the area utility company's ticket information. This allows for greater flexibility because future tracking methods for locating utility lines would only have to communicate with single ticket database 340 instead of multiple utility databases 322. Further, in some embodiments, ticket database 340 can be a single database that is securely partitioned by utility, and by user (allowing various levels of access, from user, analyst, to administrator). In some embodiments, ticket database 340 can represent a multitude of databases, each of which is scoped to include all users belonging to a particular utility company.

In addition, locators 200 are interfaced to ticket database 340. Because locators 200 are interfaced with the ticket database, the administrators have the ability to reconfigure locators 200 on command. Reconfiguration of locators 200 can include upgrading the locator software, adding new software, updating the configuration, diagnosing the hardware components, and invoking self-calibration operations of locator 200.

The administrators of ticket database 340 can, in some embodiments, charge users for access to the ticket database ticket records. The users and customers of ticket database 340 can access network 300 by connecting to the Internet. For example, a locator technician 110 can log onto a web page (for example, FIG. 31B) from locator 200 or from a computer, which can be coupled to locator 200, in order to access ticket database 340. In some embodiments the webpage can distinguish the difference between users and allow the accessibility of information to be filtered based on the type of user. In addition, a location technician with locator 200 has the ability to perform one or more of the following functions: acquire open tickets, acquire a list of the daily tickets to be filled, synchronize ticket data between locator 200 and ticket database 340 and reconfigured ticket data with the ticket database, acquire driving directions to the jobsite, and acquire database queries and reports.

Locators 200 receive through the communication interface the necessary ticket data from the ticket database via the network. In some embodiments, a user interface (not shown) may be linked between the locator and the ticket database. The user interface may be a web-enabled personal computer, a hand-held processor device, a cell phone, a personal digital assistant, a workstation, a server, or a laptop. The user interface can be configured to connect directly to network 310. The user interface can be configured to include Internet browser software or any network-based software and software applications for transferring data between the user interface and locator 200 or network 310.

Once locator 200 has updated the ticket data, as described above, locator 200 transmits the reconfigured ticket data to network 310. The reconfigured ticket data can proceed from network 310 to ticket database 340. Ticket database 340 has the ability to update its ticket data records with the reconfigured ticket data from locator 200. Once the ticket data update has occurred, ticket database 340 has the ability to transmit the necessary reconfigured ticket data to network 310. Utility database 322 can then receive at least some of the reconfigured ticket data from network 310. This process of updating the utility database is known as “synchronization.” Synchronization is used to provide utility database 322 with at least some of the updated ticket records. Ticket database 340 can have the ability to store all of the ticket data records for each of the area's utility companies 320 and 330. In some embodiments of the invention, ticket database 340 can communicate with OneCall center's database 305 directly or through a network 310 in order to synchronize at least some of the ticket data at the databases and to notify whether an area can be excavated or not based on ticket database's 322, 332, and 334 ticket data.

Once OneCall center 300 receives at least some of the ticket data through network 310 from utility company 320 or ticket database 340, OneCall center 300 can then notify a third party whether an excavation can be performed at the corresponding site. In some embodiments, ticket database 340 has the ability to directly notify the third party that the excavation can be performed.

FIG. 3B illustrates an example web page for synchronizing the ticket data according to some embodiments of the present invention. As shown above, this web page can be displayed by a locator 200 or by a computer, which is coupled to the locator 200, in order to access the ticket database 340. The web page has the ability to display connection information. As shown in display section 360, the connection information can include the locator's type, serial number and software version. Connection information can further include the type of communication signal, the strength of the communication signal, etc. The location technician 110 can download new ticket data into the locator 200 from the network 310 or the ticket database 340 by selecting button 375. The location technician can view these new ticket request orders at display section 370. Once the tickets have been completed with the reconfigured ticket data, the location technician 110 has the ability to upload the completed ticket data, display section 380, from the locator to the network 310 or the ticket database 340 by selecting button 385. The completed, uploaded ticket data synchronizes the ticket data records at the ticket database 340. Further, the location technician 110 has the ability to navigate to other web pages by selecting any link in link section 390.

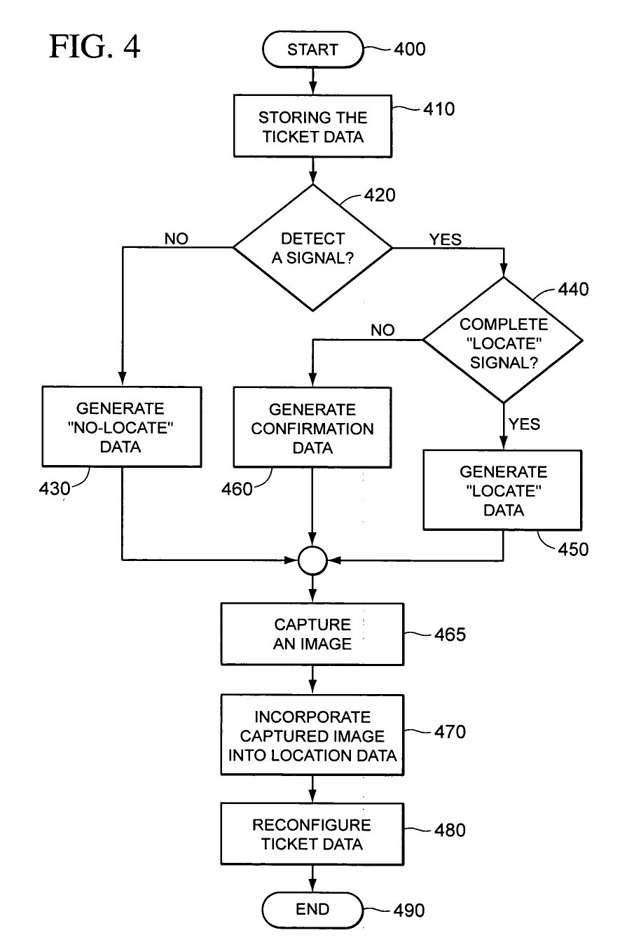

FIG. 4 illustrates a flow chart illustrating a procedure for reconfiguring the ticket data at locator 200, such as that shown in FIGS. 2A and 2B, according to some embodiments of the present invention. It will be readily appreciated by one of ordinary skill in the art that the illustrated procedure can be altered to delete steps or further include additional steps. In some embodiments, the procedure for reconfiguring the ticket data can occur solely at locator 200, the user interface or a combination of both. After initial start step 400, locator 200 has the ability to store ticket data within its memory at step 410. In some embodiments, locator 200 receives the ticket data from the network, the ticket database or the user interface. In addition, the ticket data can be any data format or a downloadable data file.

After storing ticket data at step 410, the procedure can decide whether locator 200 detected a locate signal from a utility line at step 420. All or part of the logged data can be used to determine the accuracy of the locate, and the integrity of the data. As described above, locator 200 can detect one or more signals from the one or more utility lines, including the raw data used to compute position and depth, GPS coordinates, visual data, and audio data. If the locate signal was not accurately detected from any or all segments of the tracked utility line, the locator has the ability to generate no-locate data at step 430. Of course, other reasons for the no-locate can exist, for example the job was reassigned or deleted based on excavator request. In these cases, the user of the locator 200 can note the reason for the no-locate. After generating the no-locate data, the procedure can proceed to reconfiguring the ticket data at step 470.

On the other hand, if the locator 200 detects a locate signal from the segments of the utility line, the locator has the ability to determine whether the locate signal is a complete signal at step 440. In some instances, the locate signal may be distorted and the locator 200 may require further confirmation for some portions of the utility line. If the locator detects a complete signal from the utility line, the locator has the ability to generate “locate” data based on the located utility line at step 450. The generated locate data can include one or more of the following: the type of the one or more utilities, the position and depths of the one or more utility lines, the received one or more radiation frequencies, the coordinates of the line for which accurate locates were accomplished, or any pertinent ticket data. After generating the locate data, the procedure can proceed to reconfiguring the ticket data at step 470.

On the other hand, if the locate signal is not a complete locate signal, the locator has the ability to generate confirmation data at step 460. The confirmation data is generated to flag the ticket data in order to notify that further confirmation of the location of the utility line is needed. In some instances, further confirmation may require “potholing” (potholing is a common procedure to selectively excavate, usually by vacuum extraction of the soil). In some embodiments the generation of the confirmation data may include the generation of the locate data in order to selectively “pothole” only necessary areas. Once again, after generating the confirmation data, the procedure can proceed to reconfiguring the ticket data at step 470.

Whether the locator generates confirmation data, locate, or no-locate ticket data, the procedure can proceed to capturing one or more visual images relating to the location where a user Is trying to detect a signal from the utility line at step 465. After the locator or the user interface process the image data, the image data can be incorporated with the location data at step 470 based on the generated data at steps 430, 450, or 460.

After incorporating the image data, the procedure can then proceed to reconfiguring the ticket data at step 480 based on the generated data at steps 430, 450, or 460. Locator 200 has the ability to reconfigure the ticket data stored at step 410 with the generated data. In addition, in some embodiments, additional data, besides the generated data, can be included with the reconfigured ticket data. This additional data can include magnetic field strength data, inertial position-tracking information, GPS coordinates of the entire locate or some portion thereof, audio input data, or any other type of input data. In some embodiments, locator has the ability to transmit the reconfigured ticket data to the network, the ticket database or the user interface. The reconfigured ticket data can be data or an uploadable data file. After reconfiguring the ticket data at step 480, the procedure can terminate at step 490. In some instances, the no-locate ticket data can be further analyzed to determine subsequent operations. As noted above, the information obtained at a site can be discriminated by GPS position, or flagged with audiovisual information.

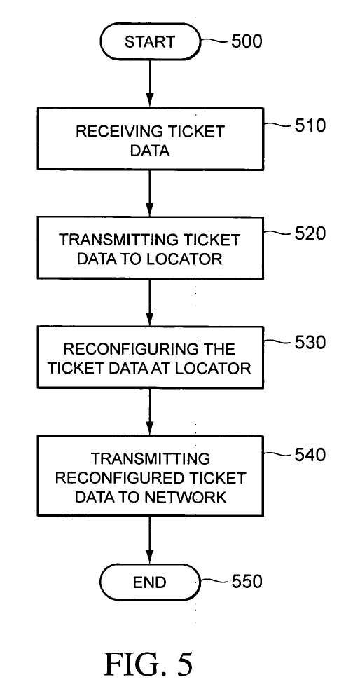

FIG. 5 illustrates a flow chart illustrating a procedure for reconfiguring ticket data within a system, such as shown in FIG. 3A, according to some embodiments of the present invention. It will be readily appreciated by one of ordinary skill in the art that the illustrated procedure can be altered to delete steps or further include additional steps. After the initial start step 500, the ticket database has the ability to receive ticket data from network 310 at step 510. In some embodiments, the ticket database can receive the ticket data from the one or more utility databases or the OneCall database.

After receiving the ticket data, the procedure can proceed to the ticket database transmitting the ticket data to locator 200 at step 520. In some embodiments, as described above, a user interface can be linked between the ticket database and locator 200. If the user interface receives ticket data from the network, the user interface has the ability to direct the ticket data to locator 200. The ticket data can be any data format or downloadable data file. Locator 200 can then also store the ticket data within its memory.

After transmitting the ticket data at step 520, the procedure can then proceed to reconfiguring the ticket data at locator 200 at step 530. As shown above, locator 200 can detect a signal from the utility line or utility line marker. Locator 200 has the ability to generate data based on receiving a signal from the utility line or utility line marker. If locator 200 detects a no-locate, the locator can generate data pertaining to that the utility line was not located. Additional data can be inputted into locator 200. The additional data can be from the GPS receiver, the inertial position-tracking device, the audio input device, the video input device or any other input means. Locator 200 can reconfigure the ticket data based upon the generated data, the additional data and the original ticket data received at the locator at step 520.

After reconfiguring the ticket data at step 530, locator 200 can transmit the reconfigured ticket data to network 310 at step 540. Once network 310 receives the reconfigured ticket data, network 310 has the ability to transmit the reconfigured ticket data to the ticket database. The ticket database then has the ability to transmit some or all of the reconfigured ticket data to the one or more utility database over the OneCall center's database. Once locator 200 has transmitted the reconfigured ticket data to the network, the procedure can terminate at step 550.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A locator comprising:
a processor;
a memory configured to store location data;
a locator circuitry coupled to the processor and configured to receive and process signals related to the location of a utility line; and
a visual data input device coupled to the processor and configured to receive visual data, wherein the processor is adapted to reconfigure the location data based on the visual data.

2. The locator of claim 1, further comprising a communication interface adapted to communicate ticket data between the processor and an external database, wherein the ticket data includes the location data

3. The locator of claim 2 wherein the processor communicates the reconfigured ticket data to a network, wherein the reconfigured ticket data includes the reconfigured location data.

4. The locator of claim 3 wherein the network includes a device that is connected to the network, wherein the device is at least one of a user interface or the external database.

5. The locator of claim 4, wherein the external database synchronizes stored ticket data by updating the stored ticket data with the reconfigured ticket data.

6. The locator of claim 3, wherein the reconfigured ticket data includes at least one of the following: ticket identification number, whether a utility line was located, whether a utility line needs confirmation, a type of the one or more utilities, the position of at least one utility line, the depth of at least one utility line, a locate frequency, an image, and an address.

7. The locator of claim 3 wherein the processor communicates with the network via a wired or wireless signal.

8. The locator of claim 2, wherein the ticket data includes at least one of the following: ticket identification number and a type of the one or more utilities.

9. The locator of claim 1, further comprising a positioning receiver coupled to the processor and adapted to receive location data.

10. The locator of claim 9, wherein the positioning receiver is at least one of a GPS receiver, an inertial position tracking device and a range finder.

11. The locator of claim 1, wherein the visual data input device is at least one of a camera or a video recording device.

12. The locator of claim 1, further comprising an audio data input device coupled to the processor and adapted to receive audio data, wherein the reconfigured ticket data includes the audio data.

13. A ticket management system comprising:
a network;
an external database adapted to store ticket data and transmit ticket data to the network; and
a locator device adapted to receive ticket data from the network, wherein the locator device processes image data relating to a location of a utility line, reconfigures the ticket data based on the processed data, and communicates the reconfigured ticket data to the network.

14. (canceled)

15. The ticket management system of claim 13 wherein the network communicates the reconfigured ticket data to the external database.

16. The system of claim 15, further comprising one or more utility databases adapted to store ticket data and communicate with the external database, the communication corresponding to at least the ticket data or the reconfigured ticket data.

17. The system of claim 16 wherein the one or more utility databases synchronizes the ticket data with at least some of the updated ticket data from the external database.

18. The system of claim 17 wherein the synchronization of the one or more utility databases automatically closes the ticket data record.

19. The system of claim 15 further comprising a center database wherein the center database communicates with the one or more utility databases or the external database through the network.

20. The system of claim 19 wherein the center database creates the ticket data and transmits the ticket data to the one or more utility databases or the external database through the network.

21. The system of claim 19 wherein the center database is synchronized with the at least some of the reconfigured ticket data from the one or more utility databases or the external database.

22. The system of claim 13 wherein the ticket data is downloadable data.

23. The system of claim 13 wherein the reconfigured ticket data is uploadable data.

24. The system of claim 13 wherein the locator device transmits the reconfigured ticket data to the network via a wired or wireless signal.

25. A method for reconfiguring ticket data at a locator, the method comprising:
storing location data at a memory;
capturing an image corresponding to a location of a utility line;
processing data based on the image; and
reconfiguring the location data based on the processed data.

26. The method of claim 25, further comprising downloading ticket data to a locator from a network, wherein the ticket data includes entries for location data.

27. The method of claim 26, wherein the network includes a device that is connected to the network, wherein the device is at least one of a user interface or an external database.

28. The method of claim 25, further comprising transmitting the reconfigured ticket data to a network, wherein the reconfigured ticket data includes the reconfigured location data.

29. The method of claim 28, wherein the reconfigured ticket data is uploadable data.

30. The method of claim 25, further comprising detecting whether a signal has been received regarding a location of a utility line.

31. The method of claim 30 wherein the detected signal is generated by a utility line or a utility line marker.

32. A locator comprising:
a processor;
a memory adapted to store location data
a locator circuitry coupled to the processor and adapted to receive and process signals related to the location of a utility line; and
a visual data input device coupled to the processor and adapted to receive visual data, wherein the processor is adapted to reconfigure the location data to include the visual data.

33. An apparatus for reconfiguring ticket data at a locator, the method comprising:
means for storing location data at a memory;
means for capturing an image corresponding to a location of a utility line;
means for processing data based on the image; and
means for reconfiguring the location data based on the processed data.
